(19) United States
(12) Patent Application Publication
(10) Pub. No.: US 2008/0085430 A1
(43) Pub. Date: Apr. 10, 2008

(54) Battery integration and control in an auxiliary power unit powered by a solid oxide fuel cell system

(76) Inventors: John A. MacBain, Carmel, IN (US); Kaushik Rajashekara, Carmel, IN (US)

Correspondence Address: DELPHI TECHNOLOGIES, INC., M/C 480-410-202, PO BOX 5052, TROY, MI, 48007, US

(21) Appl. No.: 11/545,216

(22) Filed: Oct. 10, 2006

(51) Int. Cl. H01M 16/00; H01M 8/12; H01M 8/04

(52) U.S. Cl. 429/9; 429/32; 429/23; 429/13

(57) ABSTRACT

An auxiliary power system providing electric power from a fuel cell stack at a nominal steady state output experiences an instantaneous voltage drop when maximum load is called for, which voltage drop can damage the fuel cell stack. Also, the required power increase cannot be provided for a short lag period during which the fuel cell fueling is ramped up. In the present invention, an electricity storage device, such as a battery, is provided in parallel with the fuel cell stack to meet the burst power demand during the fuel cell ramp-up lag. Various alternative control mechanisms are disclosed to assure that the necessary power is provided while also protecting both the fuel cell stack and the battery from damaging voltage swings. A vehicular application with a shared vehicle battery is also disclosed.

### TECHNICAL FIELD

The present invention relates to fuel cell systems for providing electric power; more particularly, to solid oxide fuel cell systems and devices for controlling their use in an auxiliary electric power unit; and most particularly, to method and apparatus for integration and control of a battery in an auxiliary power unit powered by a solid oxide fuel cell system.

### BACKGROUND OF THE INVENTION

Fuel cell systems for converting hydrogen, carbon monoxide, and oxygen into carbon dioxide and water to generate electricity are well known. One such type of fuel cell system is known in the art as a solid oxide fuel cell (SOFC) system. A known use for an SOFC system is as an auxiliary power unit (APU) for providing supplemental electric power to an associated function having another, primary source of electric power.

One example of an APU application is in a vehicle, which may be motively powered by an internal combustion engine, gas turbine engine, or electric motor and which may generate its own electric power for operating the engine and charging an onboard battery. Auxiliary power requirements, such as operating air conditioning, lights, electric heaters, power windows, and the like which are parasitic on the efficiency of the motive power source are off-loaded to an APU, at a net increase in fuel efficiency.

Another example is in a building wherein the primary electrical needs are met by connection to an electric grid, and an APU serves as a back-up power source in event of failure of the grid connection and also is a potential source for building heat and potable water.

These two applications may be combined in applications wherein the APU is resident in a vehicle and is connected to the building when the vehicle is not in mobile service.

Yet another example is in a building wherein the primary electrical needs are met by an APU, as in a building remote from an electric grid, wherein the APU performs the role of an electricity generator for general use.

An SOFC system includes at least one system controller that governs the flow of fuel to a hydrocarbon fuel reformer, for generating H₂ and CO from hydrocarbon fuels, and also governs the flow of air to the reformer and to the SOFC cathode. The SOFC stack must be maintained at optimum fuel utilization levels and optimum operating temperatures, which typically are in the range of about 700° C. to about 900° C.

Transient operating conditions wherein there is a sudden change in load (for example, from 0% to 100%, or from 100% to 0%) can result in a demand for a sudden change in fuel input into the SOFC stack. In practice, there is always a time lag of several seconds to effect the required change in fuel flow to the stack anode and air flow to the stack cathode. Consider, for example, a sudden increase in load. Because of the fueling lag, the stack voltage per cell will fall, most likely to below the desired value, leading to increased fuel utilization, thus resulting in lower efficiency. The sudden increase in load may also starve the cell of fuel, leading to potential cell damage.

In some applications, the rate of change of the load is controlled to limit sudden changes in the fuel cell stack voltage. However, limiting the rate of load change can limit the performance of the total system, and hence performance of the application. A battery may be connected in parallel with the fuel cell to provide power during transient conditions. However, the battery itself may see a large swing in voltage, leading to reduced lifetime. Also, the fuel cell stack may still be subject to massive instantaneous drops in voltage which can cause damage. See, for example, U.S. Pat. No. 6,989,211.

What is needed in the art is an APU system having means for allowing application of a sudden load to a fuel cell stack, wherein an integral, parallel-connected battery is maintained within a non-damaging voltage range; and wherein the fuel cell stack is also maintained within a non-damaging voltage range; and wherein an associated load on the APU system can receive the required power.

It is a principal object of the present invention to meet a load or load change imposed on an APU system without extending either an APU battery or an APU fuel cell stack beyond a non-damaging voltage range.

### SUMMARY OF THE INVENTION

Briefly described, an auxiliary power unit (APU) providing electric power from a fuel cell stack at a nominal steady state output experiences an instantaneous voltage drop when maximum load is called for, which voltage drop can damage the fuel cell stack. Also, the required power cannot be provided for a short lag period during which the fuel cell fueling is ramped up. In the present invention, a battery source is provided in parallel with the fuel cell stack to meet the burst power demand during the fuel cell ramp-up lag. Various control mechanisms are disclosed to assure that the necessary power is provided while also protecting both the fuel cell stack and the battery from damaging voltage levels. A vehicular application with a shared vehicle battery is also disclosed.

### BRIEF DESCRIPTION OF THE DRAWINGS

The present invention will now be described, by way of example, with reference to the accompanying drawings, in which:

FIG. 1 is a schematic drawing of a first embodiment of an APU including battery integration and a voltage management system in accordance with the invention;

FIG. 2 is a first sub-embodiment of control hardware for use in the system shown in FIG. 1;

FIG. 3 is a second sub-embodiment of control hardware for use in the system shown in FIG. 1;

FIG. 4 is a third sub-embodiment of control hardware for use in the system shown in FIG. 1;

FIG. 5 is a schematic drawing of a second embodiment of an APU including battery integration and a voltage management system in accordance with the invention; and

FIG. 6 is schematic drawing of a third embodiment of an APU including battery integration and a voltage management system in accordance with the invention.

Corresponding reference characters indicate corresponding parts throughout the several views. The exemplification set out herein illustrates several preferred embodiments of the invention, and such exemplifications are not to be construed as limiting the scope of the invention in any manner.

### DESCRIPTION OF THE PREFERRED EMBODIMENTS

As noted above, in the prior art of SOFC APU systems, the electrical load (internal parasitic plus external) on the APU must be carefully controlled. The principal reason why this is so is that the fuel cell stack tends to run above a certain voltage per cell, for too low a cell voltage can cause very high cell temperatures resulting in cell failure. The stack also tends to run below a ceiling value of fuel utilization.

A critical control challenge occurs in an APU when the electrical load transitions from idle to full load. Sensing this additional load by a system controller causes an increase in fuel flow; however, an inherent lag exists in providing increased flow of anode and cathode gases. In a known hydrocarbon reformer system for feeding fuel gas to the fuel cell stack, this time lag is approximately two seconds. As a result, the stack voltage per cell instantaneously falls, and can fall below a desired voltage floor. Moreover, the system will likely fall to a voltage where fuel utilization will approach 100%, or even exceed 100%, creating an unrealistic situation wherein a current (other than fuel cell created) is forced through the stack, creating a V=IR drop which is potentially destructive to the stack.

To prevent such an undesirable and potentially catastrophic situation, the present invention integrates a battery into an SOFC APU system such that three goals are achieved:
1. The fuel cell cannot be damaged by sudden changes in total electrical load on the APU;
2. The battery is maintained within a voltage range where it will not sustain damage; and
3. The electrical loads of the APU, both internal and external, can receive the requested voltage or current when requested.

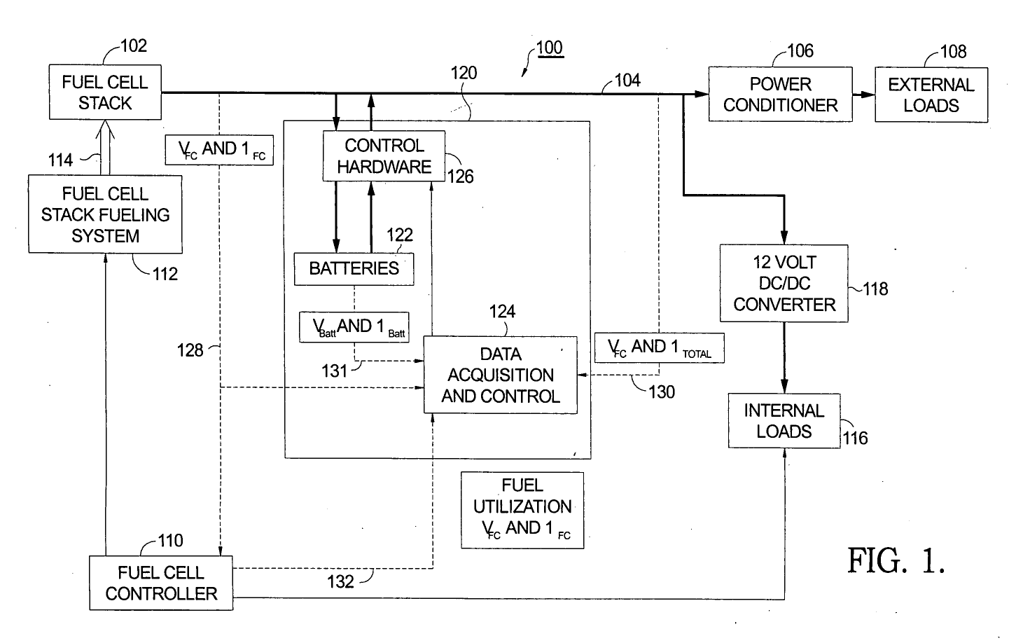

Referring to FIG. 1, a first APU system 100 in accordance with the invention includes a fuel cell stack 102 for supplying power through an output power bus 104 and through a power conditioner 106 to an external load 108. Stack 102 is controlled by a master fuel cell controller 110 that directs a fuel cell stack fueling system 112 supplying fuel and air 114 to stack 102. Controller 110 also controls internal power loads 116 via a DC/DC converter 118, preferably 12 volt, tapped into power bus 104.

A battery sub-system 120 includes one or more rechargeable batteries 122 and a data acquisition and control center 124 for controlling a control hardware module 126 disposed between batteries 122 and power bus 104. Control hardware module 126 preferably is bidirectional to permit power flow from batteries 122 into bus 104 as needed to meet instantaneous power demand from load 108 or to permit recharging of batteries 122 by fuel cell stack 102 during periods of surplus power generation headroom for the fuel cell in system 100. Data acquisition and control center 124 receives input 128 on voltage and current output of fuel cell stack 102; bus voltage and total current 130; battery status 131; and information 132 from master fuel cell controller 110 regarding fuel utilization.

To integrate a battery into an APU system at minimal cost, a system (not shown) similar to APU system 100 may be assembled without control hardware module 126, battery 122 being hardwired into bus 104. In such an arrangement, the control logic is that whenever the electrical load (internal parasitic and external) on the APU increases, the battery “catches” the system voltage as it falls and sustains it at a predetermined acceptable voltage while the fueling rate (reformate and air) of the fuel cell catches up through its inherent lag period. The catching of the fuel cell voltage is important for four reasons:
1. It prevents substantial voltage drop in the electrical loads, thus meeting user expectations;
2. It prevents the fuel utilization (FU) from exceeding a ceiling threshold, perhaps 90%, which could cause fuel cell damage;
3. It prevents the fuel cells from operating at a very high temperature causing potential thermal distress or damage; and
4. It prevents the voltage per cell from falling below a specified floor value, perhaps 0.6V/cell, which could also cause fuel cell damage.

### The need of the fuel cell stack is to reduce the voltage difference between idle system conditions and full load conditions that would be experienced when the electrical load switches instantly from idle to full (typically the worst case situation).

A system without some element of control hardware module 126, however, is not robust. While in the process of providing a safety net for the fuel cell, the battery itself must be maintained within the voltage range for which it is designed. For instance, a 36V lead acid battery should not experience voltages above 42 volts (approximate), for that could cause battery damage and/or shortened battery life. Likewise, the same battery will sustain damage and diminished performance if it is ever allowed to discharge substantially to a low state of charge (SOC). (Limitations vary by battery chemistry and technology.) It must also be understood that battery performance and voltage varies over a state of charge (SOC) range that is deemed acceptable to the battery; that voltage varies with battery current and state of charge (SOC), that the open circuit voltage (OCV) varies with the SOC; and that both may also vary over the anticipated temperature range of the battery application. The SOFC and battery criteria must be met for all anticipated battery conditions.

Of course, the number of cells in the stack and the active area must be properly sized to be compatible with the battery voltage and power. Such sizing involves the use of data tables or simulations and is quite straightforward for one of ordinary skill in the electrical arts, using both the fuel cell and battery criteria already specified. Depending upon battery and stack sizes, the steady state condition for the system at full electrical power can be: a) discharging the battery, or b) no current through the battery, or c) charging the battery. The viability depends upon the battery open circuit voltage curve. For lead acid batteries, the OCV is relatively flat over a wide range of SOC; most other battery technologies are even flatter. All will fall off in OCV voltage at some low SOC value, wherein this voltage varies with technology.

For viability, the system must sustain the battery at an acceptable charge level during sustained full electrical load conditions, which is a worst case scenario. If the steady state voltage is in the flat OCV zone of the battery, there is a chance it will stabilize with no current flowing through the battery. However, this would not be a viable design because variations in temperature or in stack performance could disrupt this delicate balance. If the voltage fell just a few volts, the battery would discharge eventually to a low SOC which would be potentially damaging. Thus, the steady state voltage for full electrical load must be comfortably above the flat zone of the battery OCV curves for the temperature range anticipated. This creates a situation wherein the battery can stabilize at an SOC in its normal operating range or approach a full charge (as automotive batteries do under continuous charging). This creates a floor for the number of cells in the stack.

The other extreme constraint is how far the system voltage will plummet when an idle load at steady state is changed instantly to a maximum load while the fueling rate (reformate and air) is at idle rate (due to lag in response time). The relative voltages of the fuel cell stack and the battery must be such that the battery can catch the system voltage before any of the potentially damaging conditions exist for the stack (see previously itemized list). The catch voltage, by necessity, will be less than the OCV of the battery.

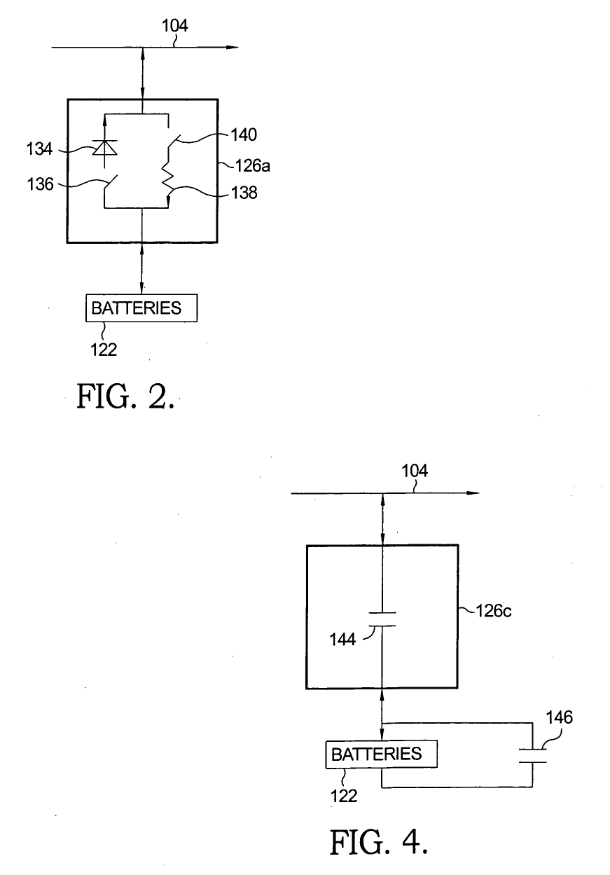

APU system 100 represents an improvement on a battery hard-wired system (without control module 126) as just discussed. In adding a control hardware module 126 between the battery and the fuel cell as shown in FIG. 1, various control options are possible, as shown in FIGS. 2-4.

Referring to FIG. 2, in a first exemplary control hardware module 126a, a diode 134 and first switch 136 are in parallel with a variable resistor 138 and second switch 140 between batteries 122 and bus 104. The diode 134 permits immediate battery response if the system voltage drops below battery OCV. The switch 136 in series with the diode 134 prevents excessive battery discharge and is timed to open after the SOFC fueling has stabilized and further battery make-up current is not needed. The parallel resistor 138 permits control of battery current when charging the battery. Charging switch 140 closes whenever the system voltage and the SOFC power level can accommodate connecting the battery for charging purposes and an algorithm in control center 124 determines from battery SOC and other parameters that opportunistic battery charging would be useful. Note that charging can occur only when the bus voltage exceeds battery OCV. If the resistor is variable, an active control algorithm can vary resistance to keep battery SOC below a specified ceiling with high R values essentially eliminating charging. Resistor 138 can also prevent battery discharge when system voltage is below battery OCV, leaving the diode branch to control the system “safety net” and discharge function.

This arrangement permits more precise control than a system without active control hardware module 126. In particular, it is more robust for it can handle some situations where full power steady state voltage is lower than battery OCV. However, the fuel cell would still be required to have substantial operating time above the OCV if integrated battery charging is desired. Key items beyond the obvious measure of battery SOC (or equivalent) to be considered would be the total power demand on the SOFC and the voltage the battery would experience if the charging switch 140 were closed.

The discharge switch 136 is closed whenever the system voltage is above the battery OCV, thus enabling the diode to perform the safety net function. When a load increase event occurs, the discharge switch (as well as the charging switch if closed at the time) is opened at such time as the fuel rate to the stack has enabled the stack to sustain the system loads, both internal and external. (For this reason, fuel rate might be controlled by known electrical load, external and parasitic, but not total load including battery load or contribution.) This opening would prevent the battery from continued discharge in the event that the full power steady state voltage would be below the battery OCV.

The fuel cell might be unable to charge the battery with a low resistance path if that would require the stack to exceed 100% desired power output, but the series resistor 138 can decrease the power flow in that path to an acceptable level. This greatly expands the window for opportunistic charging of the battery (from the perspective of SOFC voltage and power). There would likely never be a reason to include a resistor in series with the diode in the discharge leg of the circuit as the switch 136 provides the only control required (maximum current flow is desired here).

It should be noted that all configurations of battery voltage assist in accordance with the invention advantageously may be operated with low-cost batteries 122, such as lead-acid batteries. High technology, expensive batteries are not required. There is no discharge of the batteries when the APU system is at full fuel cell power, and no deep battery discharge ever occurs.

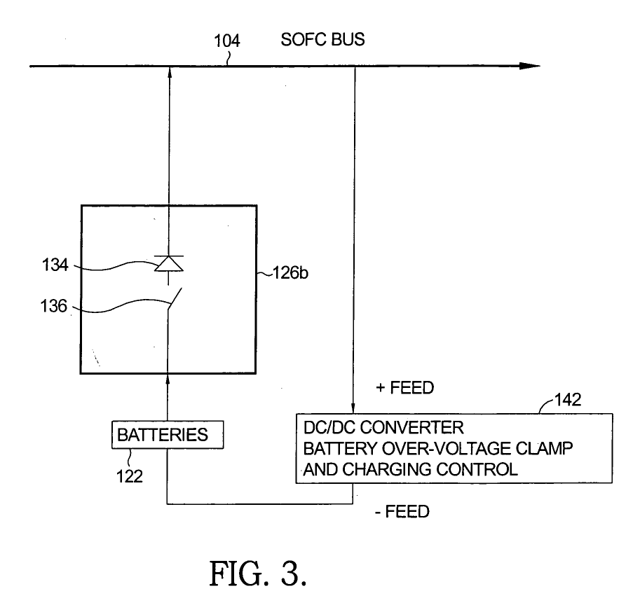

Referring to FIG. 3, in a second exemplary control hardware module 126b, the charging of battery 122 is taken out of the control hardware module and is provided by a separate DC/DC converter 142 (a “buck” converter) connected across the battery 122 and drawing power from SOFC output bus 104. The safety net diode 134 and discharge switch 136 are as in FIG. 2. Converter 142 ceases operation and discharge switch 136 closes if the bus voltage drops during battery charging.

This concept permits the safety net function as well as battery charging control.

If the components are properly sized, it can accommodate continuous operation while maintaining the battery SOC. The function of the buck converter is to provide a) a controlled voltage to the positive battery terminal to charge the battery when desired at a desired charge current or power level; b) a voltage clamp at the positive battery terminal to protect the battery from an over-voltage condition; and c) no output to the positive terminal of the battery when battery charging is not desired. If the battery is a 36V lead acid battery, the clamp value could be 42V. The buck converter would have to relinquish any load demand on the SOFC when system voltage falls due to a large electrical load onset. (The converter in this embodiment provides no system catch function, and is itself a load on the SOFC.) There would most likely be a “disable” state for the converter that could be triggered by several criteria, the most obvious being a discharge current from the battery. Likewise, the disable could be triggered by a sudden battery or SOFC voltage drop or by tracking the battery OCV and detecting a battery voltage below the battery OCV.

The charging rate of the battery can be controlled by adjusting the output voltage of the buck converter. This charging rate can be determined by a collection of parameters that should include the battery SOC or equivalent (does it really need to be charged?), the power demand on the SOFC by the system loads (keep the total SOFC power below the targeted full power level), and a good charging current for the battery (rapid charging often is not good for the battery).

Referring to FIG. 4, in a third exemplary control hardware module 126c, there is no desire to charge the battery which would be done offline, or else the battery is charged by an external power source. A first capacitor 144 is disposed between the batteries 122 and the SOFC bus 104 for providing a burst of power into bus 104 as voltage therein drops with a sudden increase in load. A second capacitor 146 is disposed across batteries 122 for ready augmentation of first capacitor 144 as described below. There is little loss of energy in the capacity/battery bank.

Once the first capacitor 144 has been adequately charged, the battery will, in the long-term, experience no net effective charge or discharge. Thus, charging the battery must be addressed only in the sense of overcoming self-discharge and capacitor leakage, an issue that can be addressed with trickle charge and/or external charging. The mechanism that supports this approach is that a given amount of charge added to the capacitor creates a larger voltage change across the capacitor than the voltage decrease it creates when leaving the battery. So, the technique is a passive sloshing of charge back and forth between the capacitor and the battery. This approach is quite robust at safely catching a range of stack sizes. The less significant problem that does occur is that there may be some temporary over-voltage issue with the battery when loads are shed. The addition of parallel capacitor 146 resolves the over-voltage issue with the battery. This approach isolates the battery from significant sustained DC current flow, thus reducing battery charging to overcoming self-discharge and capacitor leakage which should be minor.

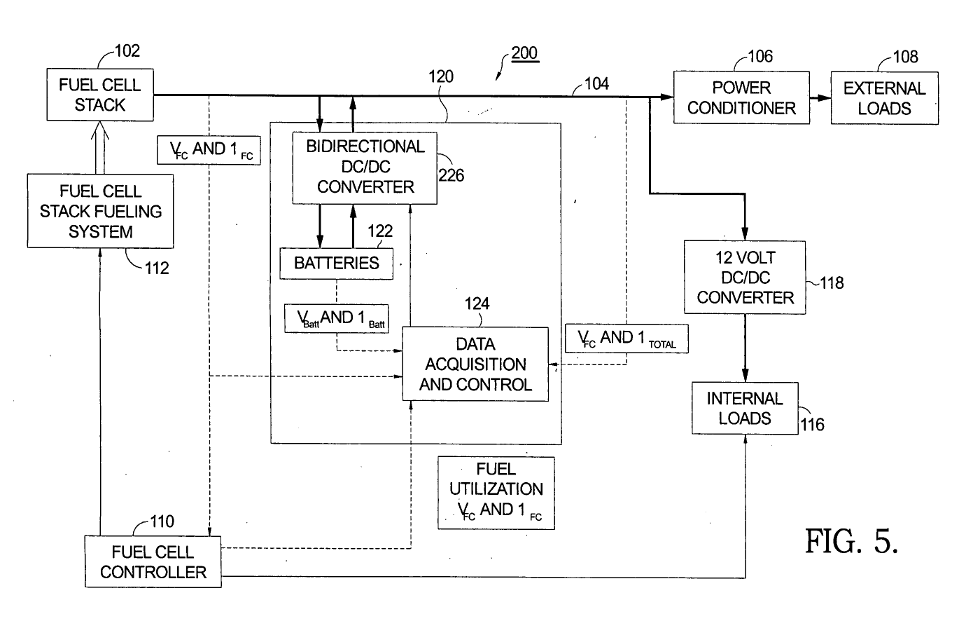

Referring now to FIG. 5, embodiment 200 is one aspect of the invention for a stand-alone APU. Control hardware module 126, as just described above, is replaced by a bi-directional DC/DC converter 226. By nature, since the converter is bi-directional, this is a buck/boost converter.

Control is relative to the voltage difference across the converter, permitting the safety net function as well as battery charging control. If the components are properly sized, bidirectional converter 226 can accommodate continuous operation (except when catching the system) while maintaining the battery SOC in a desirable range. This system is robust in that it eliminates any need to pair battery and SOFC voltages, requiring only sufficient battery capacity relative to the loads and the SOFC.

In one method of control, the DC/DC converter 226 is set to provide power from the battery to the bus at 2V below bus voltage. This, therefore, is a “floating” setpoint. When bus voltage falls, as by instantaneous load increase, the converter output voltage target is gradually lowered, while the battery provides power to the bus, until the floating set point again achieves bus voltage minus 2V, allowing time for the fueling lag of the SOFC to provide all load power required. A lag filter (not shown) may be incorporated to provide this function. When bus voltage rises, the converter output voltage target is rapidly increased to track bus voltage minus 2V.

When the battery requires charging and the fuel cell stack can produce more power, charging is accomplished and controlled by increasing fueling to the SOFC and holding the voltage differential across the converter to maintain the battery terminals somewhat above the battery OCV. While charging, the converter is still positioned to instantly switch to boost or catch mode if the bus voltage drops quickly.

Note that while the battery is charging, the safety net is in place. The battery is already connected. The fueling level of the SOFC is already elevated due to the battery charging load which places the SOFC in a better position than if the battery were not connected, given the same electrical system load.

The rate of battery charging (current) may be controlled by controlling the voltage difference across the converter, with a lower difference causing a larger rate of battery charging. Alternatively, the rate may be controlled by driving the SOFC to a desired total power output that comprises the system load and the battery charging load.

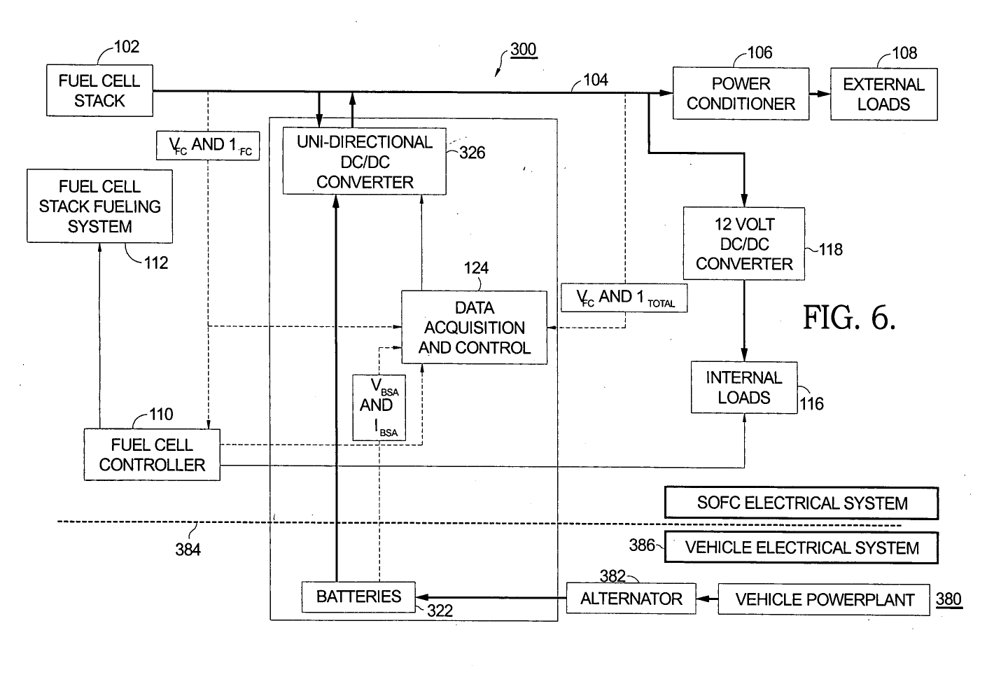

Referring now to FIG. 6, third embodiment 300 is an aspect of the invention for a vehicular application for an APU. In the embodiment, the control hardware module, just described above as a bidirectional DC/DC converter 226, may be replaced by a uni-directional DC/DC converter 326. In this embodiment, the APU lacks a dedicated battery and rather shares the battery 322 of a vehicle 380. Because battery 322 is maintained in charge by the vehicle alternator 382, power flow between battery 322 and APU power bus 104 is controlled in only the battery-discharge direction.

The vehicular application may be anything from a sedan to an over-the-road truck/trailer system, an aircraft, a spacecraft, or a marine vessel. The APU may be used to power anything from overnight “hotel” loads from the cab of the truck to normal electrical load during truck operation to electrical loads related to the trailer or cargo.

In FIG. 6, the dashed line 384 shows the separation of the SOFC system and its electrical loads 108 (considered separate for the sake of this drawing, but not necessarily separate loads) as distinct from the main electrical system 386 of the vehicle 380.

During vehicle operation, there is negligible impact on the battery, as the generator will keep it charged to an adequate state of charge (SOC). During vehicle down times such as an overnight in a rest stop, the SOFC impact on the battery is also negligible, for there would be a limited number of times that the SOFC would experience a significant step load increase.

The reason for the DC/DC converter 326 is that the voltage on the vehicle bus can vary considerably as can also the SOFC bus voltage depending upon SOFC load. Thus, a fixed voltage difference across the DC/DC converter would not be viable. The suggested control strategy is the “floating” setpoint strategy described previously which would be robust over all temperatures for the battery, all operating voltages of the SOFC bus, and all operating voltages of the vehicular electrical system.

If necessary, a bidirectional converter control strategy as in FIG. 5 may be employed in a vehicular application if the battery demand (e.g., overnight running a semi cab hotel) has enough load jumps to require some charging activity for the battery. This would preclude having to start the vehicle's internal combustion engine (ICE) to recharge the battery during the night. In either approach, there would be safeguards to prevent the discharge of the battery below a “safe zone” having enough power available for restart of the ICE.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A fuel cell system for variably providing electric power to meet a variable load, the system comprising:
a) a fuel cell stack;
b) a power bus connecting said fuel cell stack to said load;
c) an electricity storage device connected to said power bus in parallel with said fuel cell stack; and
d) a control module component connected to said electricity storage device for varying electrical discharging from said electricity storage device into said power bus to augment power output from said fuel cell stack.

2. A fuel cell system in accordance with claim 1 wherein said fuel cell stack is a solid oxide fuel cell stack.

3. A fuel cell system in accordance with claim 1 wherein said electricity storage device is a lead acid battery.

4. A fuel cell system in accordance with claim 1 wherein said control module component for varying electrical discharging is selected from the group consisting of a diode disposed between said electricity storage device and said power bus, a capacitor disposed between said electricity storage device and said power bus, a uni-directional DC/DC converter, a bi-directional DC/DC converter, and combinations thereof.

5. A fuel cell system in accordance with claim 4 wherein said control module component for varying electrical discharging, that includes a capacitor disposed between said electricity storage device and said power bus, further includes a second capacitor disposed across terminals of said electricity storage device.

6. A fuel cell system in accordance with claim 1 further comprising a control module component connected to said electricity storage device for charging said electricity storage.

7. A fuel cell system in accordance with claim 6 wherein said control module component for charging said electricity storage device is selected from the group consisting of a variable resistor disposed between said electricity storage device and said power bus, and a DC/DC converter disposed between said electricity storage device and said power bus.

8. A vehicle comprising:
a) an onboard source of primary electric power generation;
b) an onboard fuel cell system for variably generating secondary electric power to meet a variable load, said fuel cell system including a fuel cell stack and a power bus connecting said fuel cell stack to said variable load;
c) an electricity storage device connected to said power bus and to said onboard source of primary electric power generation; and
d) a control module component connected to said electricity storage device for varying electrical discharging from said electricity storage device into said power bus to augment power output from said fuel cell stack.

9. A vehicle in accordance with claim 8 wherein said electricity storage device is rechargeable by said onboard source of primary electric power generation.

10. A vehicle in accordance with claim 8 wherein said control module component for varying electrical discharging is selected from the group consisting of a diode disposed between said electricity storage device and said power bus, a capacitor disposed between said electricity storage device and said power bus, a uni-directional DC/DC converter, a bi-directional DC/DC converter, and combinations thereof.

11. A fuel cell system in accordance with claim 8 further comprising a control module component connected to said electricity storage device for charging said electricity storage.

12. A fuel cell system in accordance with claim 11 wherein said control module component for charging said electricity storage device is selected from the group consisting of a variable resistor disposed between said electricity storage device and said power bus, and a DC/DC converter disposed between said electricity storage device and said power bus.

13. A method for providing instantaneous load power to a variable electrical load connected to a fuel cell stack by a power bus, comprising the steps of:
a) connecting a electricity storage device to said power bus in parallel with said fuel cell stack;
b) disposing a control module component between said electricity storage device and said power bus to regulate power flow from said electricity storage device into said power bus;
c) setting a setpoint of said control module component such that the steady state voltage of said power bus is higher than the set output voltage of said control module component, to prevent discharge of power from said electricity storage device into said power bus;
d) discharging power from said electricity storage device via said control module component into said power bus to assist in meeting said instantaneous load power whenever the voltage of said power bus is less than said set output voltage of said control module component.

14. A method in accordance with claim 13 comprising the further step, during step d), of slowly resetting said setpoint of said control module component such that the reduced voltage of said power bus is again higher than a set to augment power output from said fuel cell stack output voltage of said control module component, to slowly terminate discharge of power from said electricity storage device into said power bus.
